(19) United States
(12) Patent Application Publication
(10) Pub. No.: US 2018/0293331 A1
(43) Pub. Date: Oct. 11, 2018

(54) DESIGN METHOD FOR CHOOSING SPECTRAL SELECTIVITY IN MULTISPECTRAL AND HYPERSPECTRAL SYSTEMS

(71) Applicant: The Government of the United States of America, as represented by the Secretary of the Navy, Arlington, VA (US)

(72) Inventors: Colin Olson, Alexandria, VA (US); Timothy Doster, Washington, DC (US)

(21) Appl. No.: 15/945,074

(22) Filed: Apr. 4, 2018

Related U.S. Application Data
(60) Provisional application No. 62/481,803, filed on Apr. 5, 2017.

(51) Int. Cl. G06F 17/50; G06F 17/18

(52) U.S. Cl. CPC G06F 17/50; G06F 2217/06; G06F 2217/12; G06F 17/18

(57) ABSTRACT

A method, wherein a first plurality of numerical support sub-regions is provided. A manufacturing constraint and a response objective are provided. A first plurality of shapes for the first plurality of numerical support sub-regions is generated. Each shape of the first plurality of shapes corresponds to a respective numerical support sub-region. Each shape corresponds to a respective function of numerical support within the respective numerical support sub-region. Each respective function of numerical support uses: a first respective center number corresponding to each numerical support sub-region, the first respective center number depending on the at least one manufacturing constraint, a first respective Beta distribution, a first respective alpha Beta distribution shape parameter constrained by the at least one manufacturing constraint, and a first respective beta Beta distribution shape parameter constrained by the at least one manufacturing constraint. A highest-rated device response is generated using the first plurality of shapes.

### CROSS-REFERENCE TO RELATED APPLICATIONS

The present application claims priority to U.S. Provisional Patent Application Ser. No. 62/481,803, which was filed on Apr. 5, 2017 and is incorporated herein by reference.

BACKGROUND OF THE INVENTION

### Field of the Invention

This invention relates in general to a method for parameterizing a weighting function for a manufacturing or digital design response target/objective, and in particular to a method for parameterizing a weighting function for a manufacturing or digital design response target/objective of a photonic system, an electrical circuit, a digital filter, an acoustic filter, an electrical filter, or an electromagnetic filter.

### Description of the Related Art

Imaging systems capture-spectral information about different objects in a scene by measuring spectral response within the scene using materials with certain spectral sensitivities. For example, ubiquitous color cameras distinguish red stop signs from green trees. In general, different materials in the scene reflect and absorb different wavelengths of light, and these differences can act as material signatures. Most imaging systems achieve spectral sensitivity by detecting the amount of energy present in different spectral hands. For example, color cameras can be thought of as spectral imaging systems with three spectral channels: the red waveband, the green waveband, and the blue waveband. These spectral channels are the result of applying optical filters which limit the wavelength of incoming light which can be sensed. In these cameras, the underlying detectors are somewhat color agnostic; they collect the energy from a relatively broad spectrum of photons. To achieve spectral selectivity, filters are placed on top of these detectors, limiting, the light each detector sees to a certain spectrum. This process can be thought of as integrating the area under a curve whose shape is governed by a multiplication of the material reflectance with the waveband of the filter placed over the detector. (For simplicity, cither effects such as scene lighting and atmospheric transmissions are ignored). Conventional color cameras array the filters in a dense pattern, with some filters passing green wavelengths, others passing red wavelengths, and still others passing blue wavelengths. Post-processing and display puts this information together into color pictures or videos.

For material detection and/or identification, these familiar color cameras typically lack spectral selectivity/differentiation; that is, dividing the incoming light into three bands does not sufficiently sample the spectra, Multi- and hyperspectral imagers seek to generate finer samplings of the spectrum (N-tuples, where N is the number of bands) such that useful identifying information about the underlying materials is not averaged out by the sampling process. At some point, however, liner spectral resolution provides diminishing returns because nearby bands can be closely correlated over a given spectral interval. In addition, a larger set of spectral channels can be problematic for tasks such as classification because the dimensionality of the spectral signature is large and subject to the “curse of dimensionality.”

This introduces the idea that there may be a certain sub-sampling of the spectrum that is optimally efficient regarding a given task. In short, what portions of the spectrum should be sampled and what is the minimum number of spectral samples required? This question could pertain to what photosensitive materials should be included in the design of a focal plane array (“FPA”) or could apply to the choice of filters that govern what wavelengths of light reach an FPA that is sensitive to a broad range of wavelengths. In either case, the problem can be cast, as an optimization that requires weighting functions of a certain shape and spectral sensitivity to be designed such that the subsequent discrete sampling of the continuous spectrum maximizes performance for the imaging task.

The problem is defined by four major components: (1) weighting function (filter) parameterization, (2) search routine, (3) forward model, and (4) the response objective. The response objective (also referred to as an objective function) measures the quality of each solution as it pertains to a desired imaging task. The forward model simulates the imaging performance corresponding to a selected set of parameters and its output is mapped to a performance measure by the response objective. The search routine governs how new parameter sets are selected for testing against the response objective and the choice of search routine is determined by the nature of the search space. For example, search spaces characterized by the presence of multiple optima require global search routines as opposed to local, gradient-based search routines. The nature of the search space is governed by the response objective and can be affected by the choice of filter parameterization. For example, discrete, binary parameterizations yield combinatorial optimizations that are generally more difficult to solve than continuous parameterizations.

In addition to affecting search space characteristics, the choice of filter parameterization must balance between the generality of the filter design and the dimensionality of the optimization problem. At one extreme, the most general parameterization would allow each spectral channel to be controlled as an independent parameter that can he either on or off. In that case, an exhaustive search would require testing, a succession of permutations which is computationally infeasible due to combinatorial complexity even choosing a modest number of spectral channels, M, from a small set of total channels, N. Alternate parameterizations trade generality for reduced dimensionality by parameterizing a low-dimensional model that selects contiguous subsets of spectral channels.

### BRIEF SUMMARY OF THE INVENTION

Art embodiment of the invention includes a method. A first plurality of numerical support sub-regions is provided. Only four numerical support sub-regions are shown for ease of understanding. One of ordinary skill in the art will readily appreciate that practical embodiments of the invention include less than four numerical support or greater than four numerical support sub-regions, depending on the application. At least one manufacturing constraint is provided. At least one response objective is provided. A first plurality of shapes for the first plurality of numerical support sub-regions is generated. Only four shapes are shown for ease of understanding. One of ordinary skill in the art will readily appreciate that practical embodiments of the invention include less than four shapes or greater than four shapes, depending on the application. Each shape of the first plurality of shapes corresponds to a respective numerical support sub-region of the first plurality of numerical support sub-regions. The each shape of the first plurality of shapes corresponds to a respective function of numerical support within the respective numerical support sub-region of the first plurality of numerical support sub-regions. Each respective function of numerical support uses:
1) a first respective center number corresponding to each numerical support sub-region of the first plurality of numerical support sub-regions, tire first respective center number depending on the at least one manufacturing constraint,
2) a first respective Beta distribution,
3) a first respective alpha Beta distribution shape parameter constrained by the at least one manufacturing constraint, and
4) a first respective beta Beta distribution shape parameter constrained by the at least one manufacturing constraint.

A highest-rated device response is generated using, directly or indirectly, the first plurality of shapes.

Another embodiment of the invention includes a method, or apparatus for designing a set of spectral filters which can be tuned arbitrarily between at least one response objective. For example, two such response objectives are maximizing target detection and maximizing spectral resolution. The target detection response objective is accomplished via maximizing the separation of target and background clusters. The spectral resolution response objective is accomplished via minimizing the error in standard compressive sensing (“CS”) recovery of a sub-Nyquist sampled spectral signature. In the embodiment of the invention the use of a standard global optimizer, for example, Differential Evolution (“DE”), is used to search the space of parameters defining the filters, and the size of the parameter space is reduced using a unique coding method.

Another embodiment of the invention includes a method for parameterizing filter designs in a manner that maintains significant design freedom (i.e., generality) while requiring fewer parameters to achieve that generality relative to other methods. In addition, when combined with a search algorithm, the continuous nature of the parameterization smooths the search space which enables faster and more consistent convergence to high-quality solutions. The disclosed method is also highly adaptable which allows for its application to a variety of imaging objectives.

Another embodiment of the invention uses a global optimizer to learn filters, at least one of which comprises a standard sensing matrix utilized in compressive sensing.

An embodiment of this new encoding and training method includes the ability to rapidly learn an optimal set of filters and the ability to constrain the trainable filters to specific industry manufacturing constraints.

Advantageously, one or more method embodiments of the invention for filter design is improved over previous methods because it; (1) maintains significant design generality while requiring fewer parameters than other methods; (2) continuously parameterizes the design space allowing fester and more consistent convergence to high-quality solutions; and (3) is highly adaptable to a variety of imaging objectives. For example, an embodiment of the invention allows for the shape of a filter to be modified and is generalized to allow multiple band-pass components on a single filter.

### BRIEF DESCRIPTION OF THE DRAWINGS

FIG. 1 is a graph showing a region of interest including a plurality of numerical support sub-regions, each numerical support sub-region including a respective center number.

FIG. 2 is a graph showing the plurality of numerical support sub-regions, each numerical support sub-region including a corresponding function of numerical support.

FIG. 3 is a graph showing a filter response comprising the plurality of numerical support sub-regions and their corresponding function of numerical support.

### DETAILED DESCRIPTION OF THE INVENTION

In the course of solving the above-mentioned optimization problem. Applicants developed the four major components that make up the general spectral selection problem and the weighting function (filter) parameterization/encoding according to an embodiment of the invention. They realized their solution's applicability to a wide range of device designs, such as manufacturing or digital designs for photonic systems, electrical circuits, digital filters, acoustic filters, electric filters, or electromagnetic filters.

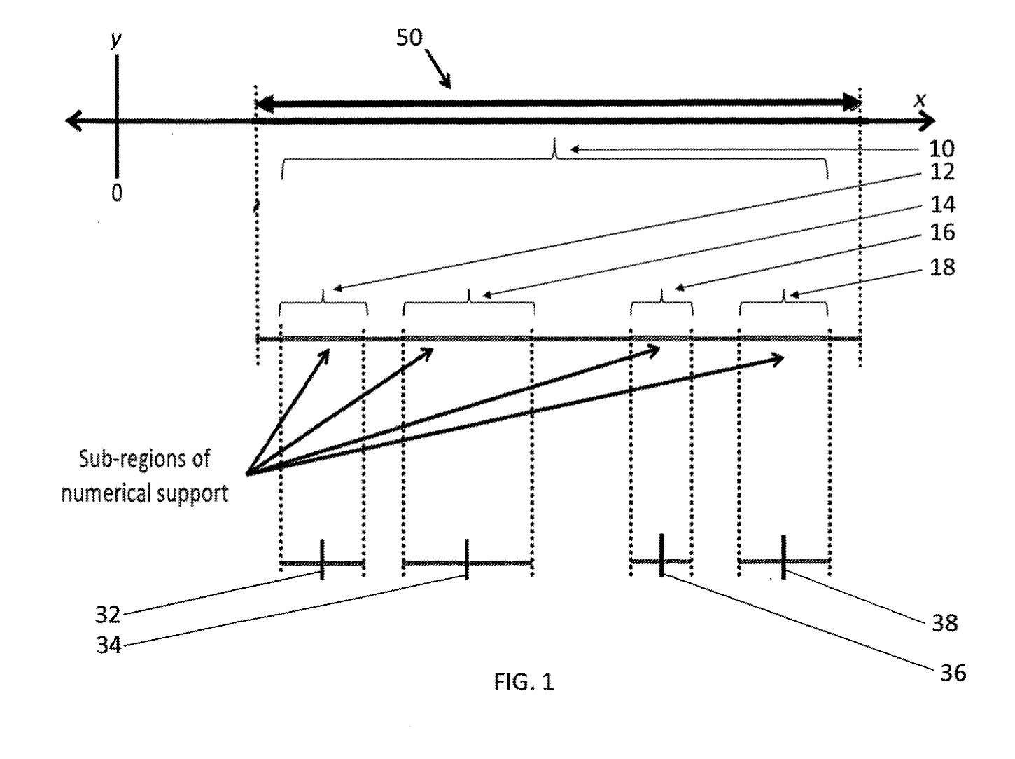

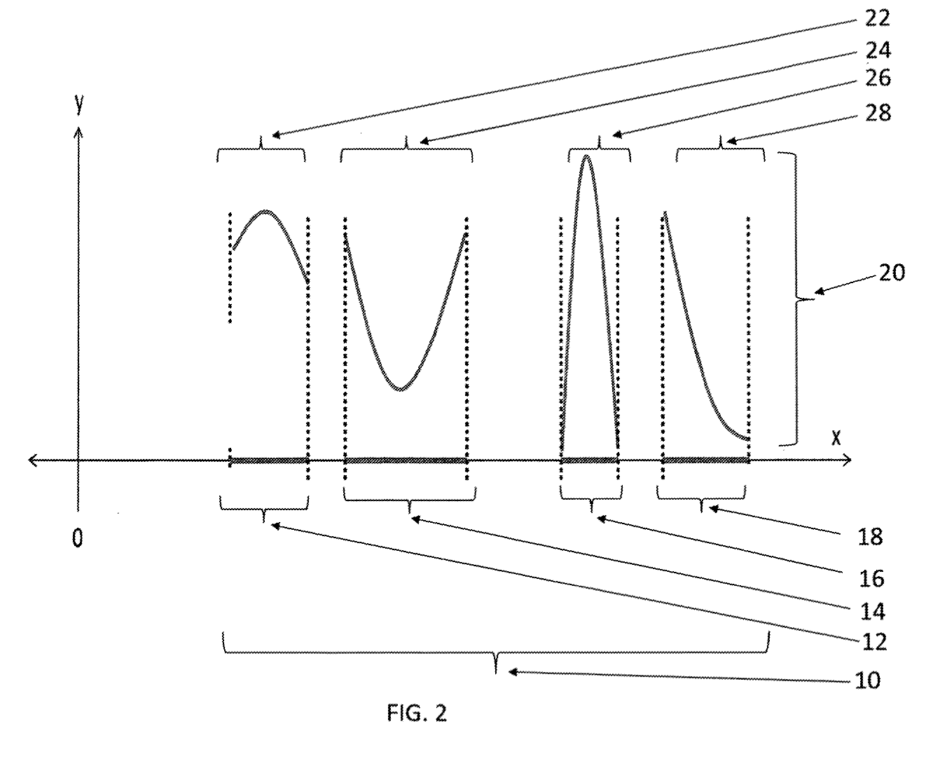

An embodiment of the invention includes a method and is described as follows with reference to FIGS. 1-3. A first plurality 10 of numerical support sub-regions is provided, as shown by way of illustration in FIG. 1. Only four numerical support sub-regions 12, 14, 16, 18 are shown for ease of understanding. One of ordinary skill in the art will readily appreciate that practical embodiments of the invention include less than four numerical support or greater than four numerical support sub-regions, depending on the application. At least one manufacturing constraint is provided. At least one response objective is provided. A first plurality 20 of shapes for the first plurality 10 of numerical support sub-regions, as shown by way of illustration in FIG. 2, is generated. Only four shapes 22, 24, 26, 28 are shown for ease of understanding and these four shapes are examples for illustration purposes only. One of ordinary skill in the art will readily appreciate that practical embodiments of the invention include less than four shapes or greater than four shapes, depending on the application. Each shape of the first plurality of shapes corresponds to a respective numerical support sub-region of the first plurality of numerical support sub-regions. The each shape of the first plurality of shapes corresponds to a respective function of numerical support within, the respective numerical support sub-region of the first plurality of numerical support sub-regions. Each respective function of numerical support uses:
1) a first respective center number 32, 34, 36,38 corresponding to each numerical support sub-region of the first plurality of numerical, support sub-regions, the first respective center number depending on the at least one manufacturing constraint,
2) a first respective Beta distribution,
3) a first respective alpha Beta distribution shape parameter constrained by the at least one manufacturing constraint, and
4) a first respective beta Beta distribution shape parameter constrained by the at least one manufacturing constraint.

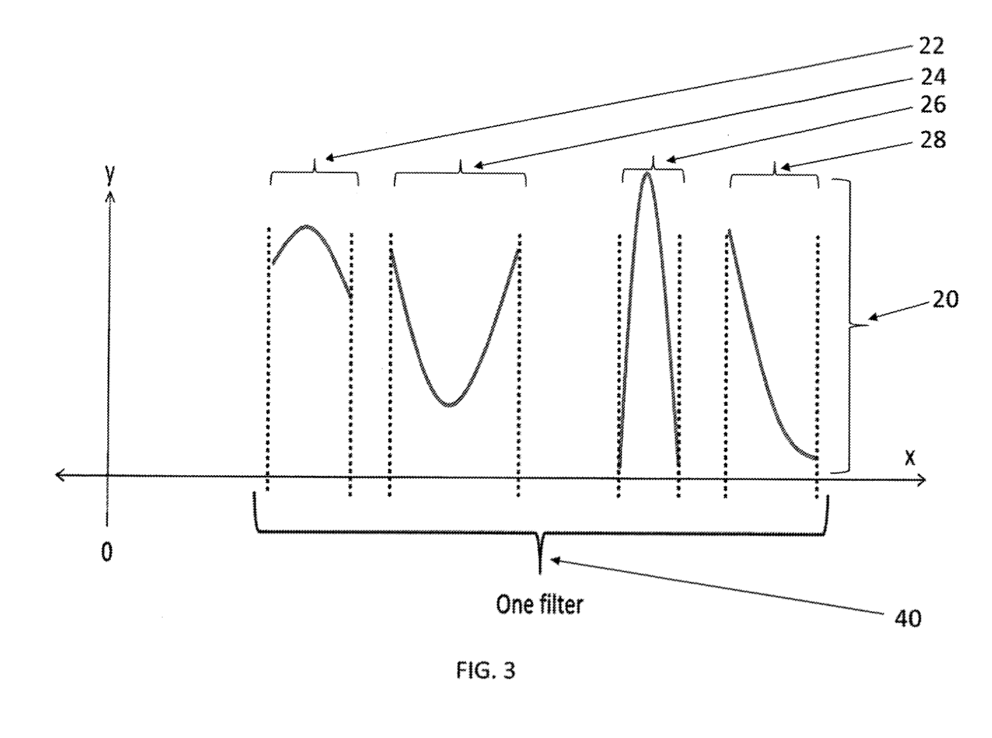

A highest-rated device response 40, as shown by way of illustration in FIG. 3, is generated using, directly or indirectly, the first plurality of shapes.

Optionally, the generating a highest-rated device response using one of directly and indirectly the first plurality of shapes includes the following. A first device response is rated against the at least one response objective. The first device response corresponds to the first plurality of shapes. Another plurality of numerical sub-regions is provided. Another plurality of shapes for the another plurality of numerical sub-regions is generated. The each shape of the another plurality of shapes corresponds to a respective function of numerical support within the respective numerical support sub-region of the another plurality of numerical support sub-regions. Each respective function of numerical support uses:
1) another respective center number corresponding to each numerical support sub-region of the another plurality of numerical support sub-regions, the another respective center number depending on the at least one manufacturing constraint,
2) another respective Beta distribution,
3) another respective alpha Beta distribution shape parameter constrained by the at least one manufacturing constraint, and
4) another respective beta Beta distribution shape parameter constrained by the at least one manufacturing constraint.
   Another device response is rated against the at least one response objective. The another device response corresponds to the another plurality of shapes. The providing another plurality of numerical sub-regions, the generating another plurality of shapes for the another plurality of numerical sub-regions, the generating a plurality of shapes for the another plurality of numerical support sub-regions, and the rating another device response against the at least one response objective, are all repeated until the highest-rated device response is generated using a standard global optimizer.

Optionally, the highest-rated device response comprises a filter response, a photonic system response, or an electrical circuit response. For the purpose of this specification, the following examples and cases illustrate the intended understanding of the terms “filters” and “filter responses.”

For the electromagnetic (“EM”) spectrum, a range of devices interact with specific wavelength regions, whose interaction and/or purpose may or may not be described as “filtering,” strictly speaking, but are nevertheless intended to be covered by one or more embodiments of the invention. For optical wavelengths, such devices include stacks of optically active material that pass certain wavelengths and block others; in other words, such devices are specifically designed to filter the spectrum. Alternatively, an electro-active material that comprises part of a focal plane array generates electrons in proportion to the intensity of electromagnetic radiation impinging on its surface; as such, it may only respond to certain wavelengths of light. In this case, such an electro-active material acts as a filter because it only responds to those certain wavelengths. As another example, an antenna designed to respond to (or to transmit) wavelengths of EM radiation that fall within the radio frequency portion of the EM spectrum also acts as a filter because the shape, format, and/or positioning of the antenna causes the antenna to respond only to certain frequencies.

In the acoustic domain, acoustic devices interact with pressure waves traversing a medium (e.g., air or water), for example, a muffler is a type of acoustic filter that alters the frequency of an impinging pressure wave by changing the size of a cavity through which the wave propagates. As another example, a microphone is a type of acoustic filter that converts pressure waves to electric signals via a variety of mechanisms (e.g., a vibrating diaphragm or a piezoelectric crystal).

In the electrical domain, frequency refers to a number of concepts. For example, frequency refers to the rate at winch current oscillates in an AC circuit. As another example, frequency refers to the modulation frequency in an FM radio. An electrical circuit is optionally designed, for example, to gather the response of an electro-active material collecting blue radiation on a focal plane array. In such an illustrative case, the electro-active material collecting blue radiation can be described by a certain frequency response. In another illustrative case, a different type of electric circuit is optionally designed to get rid of (i.e., filter) high-frequency noise that is inadvertently collected by a microphone.

In the optical domain, for example, a photonic system multiplexes and demultiplexes signals from fiber optic communication cables. Such a photonic system's frequency response is important to the extent that it filters signals to be transmitted or to be received.

Optionally, a filter corresponding to the filter response, a photonic system corresponding to the photonic system response, or an electrical circuit corresponding to the electrical circuit response is built. Optionally, the filter includes a digital filter, an acoustic filter, ;an electric filter, or an electromagnetic filter. For example, if the x-axis of the graph shown in FIG. 2 represents optical wavelengths, then an optical is her response corresponds to the optical integration of shapes 22, 24, 26, and 28. An optical filter is constructed to produce that optical filter response by stacking appropriate layers of optically active materials, each layer corresponding to a respective shape of the shapes 22, 24, 26, and 28. As another example, if the x-axis of the graph shown in FIG. 2 represents electrical frequencies, then an electrical circuit response corresponds to the sum of shapes 22, 24, 26, and 28. An electrical circuit is then constructed to produce that electrical circuit response. Optionally, a filter array including the filter, a filter wheel including the filter, a focal plane array including the filter, or a scanning array including the filter is built.

Optionally, the at least one manufacturing constraint includes a standard wavelength-dependent filter roll-off, a standard wavelength-dependent separation between adjacent sub-regions of the plurality of sub-regions, a standard manufacturing tolerance, a standard minimum transmission manufacturing threshold, a standard maximum transmission manufacturing threshold, and/or a standard filter-top flatness.

Optionally, the at least one response objective includes standard signal recovery error minimization, standard target detection error minimization, standard anomaly detection error minimization, standard change detection error minimization, standard classification error minimization, and/or standard unsupervised cluster separation.

Optionally, the global optimizer includes a standard deterministic global optimizer, a standard stochastic global optimizer, a standard heuristic global optimizer, or a standard meta-heuristic global optimizer. Optionally, the deterministic global optimizer comprises a standard branch-and-bound global optimizer or a standard interval global optimizer. Optionally, the stochastic global optimizer includes standard Monte-Carlo sampling or standard stochastic tunneling. Optionally, the heuristic global, optimizer includes a standard evolutionary global optimizer, a standard swarm-based global optimizer, a standard ant colony global optimizer, a standard simulated annealing, or a standard tabu-search-based global optimizer. Optionally, the meta-heuristic global optimizer includes a standard evolutionary global optimizer, a standard swarm-based global optimizer, a standard ant colony global optimizer, a standard simulated annealing global optimizer, or a standard tabu-search-based global optimizer.

Optionally, a region of interest 50 includes the first plurality 10 of numerical support sub-regions 12, 14, 16, 18 and/or the another plurality of numerical support sub-regions. The region of interest 50 includes a spectral region of interest comprising a plurality of electromagnetic wavelengths, an acoustic region of interest comprising a plurality of acoustic wavelengths, or an electrical region of interest comprising a plurality of electrical frequencies.

Optionally, the first plurality of numerical support sub-regions are overlapping and/or disjoint, and the another plurality of numerical support sub-regions are overlapping and/or disjoint. For ease of understanding, adjacent numerical support sub-regions in the first plurality of numerical support sub-regions shown in FIG. 1 are disjoint. In practice, depending on the application, an embodiment of the invention optionally includes at least two adjacent numerical support sub-regions in the first plurality of numerical support sub-regions that overlap and or at least two adjacent numerical support sub-regions in the another plurality of numerical support sub-regions that overlap.

Another embodiment of the invention is described as follows with reference to FIGS. 1-3.

### Filter Encoding

A spectral region of interest; [λₘᵢₙ^{B}, λₘₐₓ^{B}], and a discrete sampling of the window, Λ_{B}, B=|Λ_{B}| is provided. Within this region of interest are numerical support sub-regions, [λₘᵢₙⁱ, λₘₐₓⁱ], with discrete samplings, Λᵢ, bᵢ=|Λᵢ| that are centered about a center wavelength λᵢ where the Λᵢ ∩ Λ_{B}≠Ø ∀ i. The spectral sampling frequency within a given numerical support sub-region is typically the same as that in other sub-regions. However, one of ordinary skill, in the art will readily recognize that the spectral sampling frequency within one numerical support sub-region need not he the same as that in other sub-regions, depending on the application. Given a sub-region a weight function (filter), Sᵢ, is defined by bᵢ transmittance values at the corresponding spectral sampling locations defined by Λᵢ. Encoding a weight function is performed by utilizing a standard Beta distribution, as described below.

The Beta distribution is a family of continuous probability distributions whose density function is:

$${f}_{beta} ( x \vert α , β ) = {{x}^{( α - 1 )} ( 1 - x )}^{( β - 1 )} \frac{Γ ( α + β )}{Γ ( α ) Γ ( β )} , \qquad [ 1 ]$$

where Γ (·) is the gamma function and α, β>0 are two shape parameters. In an embodiment of the invention, the Beta distribution is conveniently mapped to the sampling of spectral response window, [0,1] [symbol] Λᵢ, and the codomain is normalized to be [0,1]. This modification of the domain and co-domain of the Beta distribution no longer meets the definition of a probability distribution; it is now just a distribution.

The Beta distribution is useful for defining weights over a domain because only two parameters are required to smoothly transition between a wide variety of possible shape functions. As such, each weight function is parameterized by the two beta function shape parameters (α, β) and the location of the sub-region domain within the overall spectral region of interest as.:

Sᵢ(λᵢ, αᵢ, βᵢ)=f_{beta}[Λᵢ |αᵢ, βᵢ], [2]

where λᵢ ∈ Λᵢ is the center wavelength of the sub-region domain. Given δ sub-regions, a complete weight function (filter) is defined as:

[symbol]

(θ)=∪ᵢ₌₁^{S}Sᵢ (λᵢ, αᵢ, βᵢ), [3]

where θ=[δ, λ₁, α₁, β₁, . . . , λ_{S}, α_{S}, β_{S}],

No modifications or limitations on sub-region overlap are required, if the strict mathematical definition, of the union operator is used to combine the Sᵢ, which is a useful construction. A more general construction.

[symbol]

ₛᵤₘ (θ)=Σᵢ₌₁^{S} Sᵢ (λᵢ, αᵢ, βᵢ), [4]

is equivalent to a union if the Λᵢ are disjoint over the domain Λ_{B}, but introduces new shape possibilities for sub-regions that intersect. Careful normalization of co-domains is optionally required in this more general intersection case.

### General Spectral Selection Problem

Given a weighting function (filter) encoding, a general description of the problem employs an response objective, g( [symbol] ), to measure the output quality of a forward model, [symbol] (D, [symbol] ), that applies a particular weighting function (filter) to a set of data, D. The response objective defined as

g(θ|D)=g( [symbol] (D, [symbol] (θ))) [5]

simplifies discussion and illustrates that the objective is ultimately a function of data and the filter parameterization.

### Weighting Function (Filter) Optimization

The formal optimization problem (shown here, without loss of generality, as a maximization) can be written as

$${θ}^{*} = {max}_{θ} g ( θ \vert D ) , \qquad [ 6 ]$$

where the goal is to find a set of filter parameters, θ* ∈ [symbol] , that maximize the response objective for a given dataset.

In general, this optimization is non-convex (i.e., characterized by the presence of multiple optima) and therefore it is useful to employ a standard global optimization algorithm (i.e., a standard search routine) that is capable of (but cannot guarantee) convergence to a global (rather than local) optimum. As an example, an illustrative global optimizer according to an embodiment of the invention includes differential evolution (“DE”), an algorithm that, by mimicking the evolutionary processes from biology, iteratively improves a set of candidate solutions, X according to the response objective function (sometimes referred to as a fitness function), g(·). During each iteration, the algorithm proposes new candidate solutions, X′, by the mutation and cross-over of members of the population of previous candidate solutions. These new proposed candidate solutions and the current candidate solutions are evaluated by the response objective, and only the top-performing (i.e., top-ranked) candidate solutions are retained for the next iteration. This process continues until a stopping condition based on the number of iterations or the output of the response objective.

### Imaging Response Objective

An embodiment of the invention is highly versatile and is applicable to a variety of imaging objectives ranging from target detection and classification to improved depth-from-defocus. To illustrate this versatility, a response-objective designed to improve target detection for a set of targets with known spectral signatures is described as follows.

### Target Classification

p ∈ I is the N-dimensional spectral pixel from a training dataset I of size N₁, [symbol] (p |θ) is a function, which applies the encoded candidate filter solution, [symbol] (θ), to a pixel p to yield the M-dimensional pixel p′. A set of indicator functions [symbol] ={ [symbol] ᵢ}ᵢ₌₁^{N}^{_{T}}, where N_{T} is the number of distinct targets is denoted:

$${i}_{} ( p ) = \{ \begin{matrix}1 & p is a member of target class i , \\ 0 & otherwise ,\end{matrix} \qquad [ 7 ]$$

with associated target spectral signatures Tᵢ ∈ [symbol] ^{N}.

A desired end-product of this embodiment of the invention is the design of a filter that increases the probability that pixels belonging to each of the target classes will be correctly assigned to their appropriate class while simultaneously limiting the number of false positive detections associated with background pixels that are erroneously labeled target pixels. A standard Adaptive Cosine Estimator (“ACE”) is used as a similarity measure to quantify how closely each transformed pixel, p′ matches a given target spectrum, Tᵢ (which has been transformed via, [symbol] (Tᵢ|θ)), given filter settings θ:

$${m}_{i} ( p \vert {T}_{i} , θ ) = \frac{{[ {( ( {T}_{i} \vert θ ) - {μ}_{BG} )}^{T} {\sum }_{BG}^{- 1} ( ( p \vert θ ) - {μ}_{BG} ) ]}^{2}}{\begin{matrix}{( ( {T}_{i} \vert θ ) - {μ}_{BG} )}^{T} {\sum }_{BG}^{- 1} ( ( {T}_{i} \vert θ ) - {μ}_{BG} ) \\ {( ( p \vert θ ) - {μ}_{BG} )}^{T} {\sum }_{BG}^{- 1} ( ( p \vert θ ) - {μ}_{BG} )\end{matrix}} , \qquad [ 8 ]$$

for a known target signature background spectral mean of all the transformed pixels,

$${μ}_{BG} = \frac{1}{{N}_{I}} {\sum }_{p ∈ I} ( p \vert θ ) ,$$

and background covariance,

$${Σ}_{BG} = \frac{1}{{N}_{I} - 1} {{Σ}_{p ∈ I} ( ( p \vert θ ) - {μ}_{BG} )}^{T} ( ( p \vert θ ) - {μ}_{BG} ) .$$

One of ordinary skill in the art will readily appreciate that other standard similarity measures are usable in oilier embodiments of the invention, depending on the application.

The mean, μᵢ^{target}, and standard deviation, σᵢ^{target}, of the ACE statistics for each target signature is measured as follows:

$$\begin{matrix}{μ}_{i}^{target} = \frac{1}{{t}_{i}} {\sum }_{p ∈ I} {m}_{i} ( p \vert {T}_{i} , θ ) {i}_{} ( p ) , & [ 9 ] \\ {σ}_{i}^{target} = \sqrt{\frac{1}{{t}_{i} - 1} {\sum }_{p ∈ I} {\vert {m}_{i} ( p \vert {T}_{i} , θ ) - {μ}_{i}^{target} \vert}^{2}} {i}_{} ( p ) , & [ 10 ]\end{matrix}$$

where tᵢ=Σ_{p∈I} [symbol] (p). Similar calculations can be made for μᵢ^{background} and σᵢ^{background} by considering (1− [symbol] (p)) instead of [symbol] (p).

To avoid the problem of saturating target separability from the background, a standard linear discriminant technique is used to define the target detection response objective:

$$g ( θ ) = {\sum }_{i = 1}^{{N}_{T}} \frac{{μ}_{i}^{target} - {μ}_{i}^{background}}{{( {σ}_{i}^{target} )}^{2} + {( {σ}_{i}^{background} )}^{2}} . \qquad [ 11 ]$$

Other standard measures for quantifying target detection quality, such as the standard raw similarity measure, the standard mutual information or the standard Battachaiya distance are usable in other embodiments of the invention, depending on the application.

### Low-Dimensional Design Generality

Filter design for target detection and/or classification is similar to that discussed above. Band or feature selection techniques seek to reduce the spectral dimensionality of a multi- or hyperspectral data set by maintaining the most descriptive spectral channels. These techniques find an optimal subset of the bands or simply an ordered ranking of all the bands for each number of retained bands.

Other standard response objectives are usable, depending on the application in other embodiments of the invention. Such other standard response objectives include standard maximizing mutual information, standard improved clustering, standard constrained energy minimization (“CEM”), standard spectral angle mapper (“SAM”) maximization, standard least angle regression (“LARS”), and standard best basis search. Band selection techniques employed in one or more of these approaches are limited to selecting fundamental spectral channels (i.e., a binary filter or delta functions), which yield high-dimensional parameter spaces that are hard to search. In addition, such solutions contain no constraints related to manufacturability. (For example, filters that approach delta functions are hard to produce in practice).

### Differentiable Response Objective Space

Continuous parameterization of filter selectivities using the Beta distribution function yields response objective spaces whose optima can be discovered more rapidly and reliably using a search routine. For example, a filter encoding scheme allows flat-top band-pass filters to discretely vary as a function of center frequency and bandwidth. This naive encoding yields a response objective space characterized by discontinuities, regions of equal response (i.e., zero derivative), and isolated islands of high-value solutions where finding the high-value solutions using a search routine is reduced to a matter of luck.

Alternatively, another filter encoding scheme varies the center frequency and shape parameter, α, of a Beta distribution where symmetry is enforced by setting β=α. This continuous encoding yields a nearly everywhere differentiable (smoother) response objective space that allows a search routine to more rapidly and reliably converge on high-value solutions. The described naive encoding scheme is in fact a feature selection problem that can be optimally solved using standard branch-and-bound algorithms, which rapidly become computationally expensive as problem size increases.

### Highly Adaptable

The adaptability of filter design according to an embodiment of the invention is illustrated by describing its application to a specific class of plenoptic cameras, a target detection problem, and a compressive sensing spectral resolution enhancement problem. One of ordinary skill in the art will readily appreciate that the described techniques are applicable to any optical system, which can support filters or where spectral selectivity must be specified.

### Camera Design

An application of an embodiment of the invention relates to spectral specificity for a standard hypersensor, such as a standard plenoptic camera. An illustrative plenoptic camera is discussed, for example, in David B. Cavanaugh, James M. Lorenx, Nora Unwin, Mark Dombrowski Paul Willson, “VNIR hypersensor camera system”, Proc. SPIE Vol 7457, Imaging Spectrometry XIV, Aug. 18, 2009, 74570O, San Diego, Calif., USA, incorporated herein by reference. For example, a standard macroscopically-sized n×m filter array is attached to the camera's lens front aperture, where each of n and m is at least one. For example, the n×m filter array is a 3×3 filter array, a 4×4 filter array, or 5×5 filter array. Such positioning of the filter array at the stop of the telecentric objective lens optionally allows for rapid change-out of the fitter sets. The filter array, for example, includes a standard mosaic filter array (“MFA”). The 16 image planes of the 4×4 filter array respectively corresponding to 16 filters are computationally extracted from the raw super-pixel filter array with appropriate corrections for cross-talk between the super-pixels. In a focal plane array region of the plenoptic camera an objective lens image is formed just behind MLA lenslet plane. Each lenslet forms a conjugate-real image of the MFA on the focal plane array. The focal plane-array is aligned with these replicated images so that each focal plane array pixel receives light from only one filter of the MFA. The MFA images are replicated over the entire focal plane array. An embodiment of the invention includes a set of designed filters, for example, at least one for specific target types and at least one for general spectral sensing. One of ordinary skill in the art will readily appreciate that, instead, of a mosaic filter array designed filters, other embodiments of the invention optionally include a standard band-stop filter, a standard broad-band filter, and/or a standard baud-pass filter. A standard micro-lens array (“MLA”) is located in close vicinity to the focal plane array.

According to an embodiment of the invention, the multi-filter specification problem is viewed as a multi-objective design where fee relative importance of various task-specific objectives is varied. An embodiment of the invention permits design of spectral, filters such that the sensor can better emphasize one or the other objective depending on their relative weightings, γ and (1−γ), γ ∈ [0,1], in the design performance function, P. Weightings that balance between target detection performance (P_{T}) and spectral resolution performance (P_{R}) are accordingly considered such that:

P=γP_{T}+(1−γ)P_{R}. [12]

One of ordinary skill in the art will readily appreciate that other standard weightings and or multi-objective optimization routines are usable in alternative embodiments of the invention, depending on application.

An embodiment of the invention allows for the specification of a set of spectral filters which can be tuned between emphasizing either of these objectives. For example, referring back to the plenoptic camera example, for camera operational modes for a L=16 filter (4×4 array) plenoptic camera. P is the total performance of the sensor, P_{T} is the detection performance, P_{R} quantifies spectral resolution and reconstruction performance, and γ is a weighting term. Target detection performance is favored when γ=1. Spectral resolution is favored when γ=0, yielding a spectral CS sensor that can recover L′>L spectral bands.

### Target Detection Objective

If the target detection task (γ=1) is emphasized, then one possible sensor design according to an embodiment of the invention is to tailor filters such that their spectral selectivity improves target detection performance. [symbol] ᵢ (p|θₗ) is a function, which applies the encoded discretized. candidate filter solution, [symbol] ₗ (θₗ), to a pixel p to yield a scalar feature value as follows:

[symbol]

ₗ (p|θₗ)= [symbol] (θₗ)·p, [13]

where · is the standard dot product.
Given L_{T} filters,

[symbol]

_{T}(p|θ_{T})=[ [symbol] ₁ (p|θ₁), [symbol] ₂ (p|θ₂), . . . , [symbol] _{L}_{_{T}} (p|θ_{L}_{_{T}})], [14]

where θ_{T}=[θ₁, θ₂, . . . , θ_{L}_{_{T}}] to yield an L_{γ}-dimensional feature vector, p′. Equations [7-11] are applied to yield the target objective,

$${g}_{T} ( {θ}_{T} ) = {\sum }_{i = 1}^{{N}_{T}} \frac{{μ}_{i}^{target} - {μ}_{i}^{background}}{{( {σ}_{i}^{target} )}^{2} + {( {σ}_{i}^{background} )}^{2}} . \qquad [ 15 ]$$

### Spectral Resolution Objective

The spectral resolution of a γ=1 design is poor because each channel provides a panchromatic image weighted by the filter. Task-specific computational load is decreased and the specificity of the sensor and its target defection performance is increased at the expense of the ability to observe a general spectrum. Conversely, emphasizing spectral resolution (γ=0), yields a spectral compressed sensing (“CS”) imager.

CS is a standard technique used to recover a signal with fewer samples than that required by the Shannon-Nyquist Sampling theorem under the restriction that the signal is sparse and the sensing matrix is incoherent relative to a selected signal model. For a recorded signal Y, a sensing matrix Φ, a signal model or basis Ψ; a CS recovery seeks to find \hat{α}, which minimizes the underdetermined system:

$$\hat{α} = {min}_{α} \{ {‖ Y - Φ Ψ α ‖}_{2}^{2} + τ {‖ α ‖}_{1} \} , \qquad [ 16 ]$$

where τ is a sparseness parameter. Equation [16 ] can be solved algorithmically by iterative minimization techniques or learned deep models. Having found the minimizer, \hat{α}, an estimate of the true spectrum can be recovered by applying the signal model,

\hat{p}=Ψ\hat{α}

For notational purposes let CS(ΦY, Ψ) be the outcome of an algorithm which returns an estimate of the underlying true signal.

Each channel of the imager in CS mode (γ=0) provides a single CS measurement composed of weighted linear combinations of spectral sub-bands for each pixel. The goal in this case is to design filters that allow reconstruction of spectral pixels with a relative resolution finer than the B/L resolution offered by a naive filter design based on uniform, disjoint spectral sampling of a fixed spectral band of size B. This operational mode requires significant computational resources as each spectral pixel must be individually reconstructed by solving the sparsity-regularized CS reconstruction program. The ability to observe a general spectrum is improved at the expense of specific target detection performance and increased computational load.

To optimize the spectral resolution p ∈ I is defined to be the N-dimensional spectral pixel from a training dataset I of size N_{I}. Using [symbol] ₗ (p|θₗ) as defined in Equation [13 ] and selecting L_{R} filters,

[symbol]

′ (p|θ_{R})=[ [symbol] ₁ (p|θ₁), [symbol] ₂ (p|θ₂), . . . , [symbol] _{L}_{_{R}} (p|θ_{L}_{_{R}})], [18]

where θ_{R}=[θ₁, θ₂, . . . , θ_{L}_{_{R}}] to produce an L_{R}-dimensional feature vector, p′, from which \hat{p} ∈ [symbol] ^{N}, an estimate of p, is calculated using the CS recovery Equations [16] and [17]. In short, the complete forward model for spectral recovery is given by;

[symbol]

_{R} (p|θ_{R})=CS( [symbol] ′(p|θ_{R}), Ψ) [19]

and our response objective becomes;

$${g}_{R} ( {θ}_{R} ) = \frac{1}{{Σ}_{p ∈ I} {‖ {R}_{} ( p \vert {θ}_{R} ) - p ‖}_{2}^{2}} , \qquad [ 20 ]$$

which quantifies how well each N-dimensional pixel in our data set is recovered, given L_{B}-dimensional samples where L_{R}<N.

End-members learned, from the standard Vertex Component Analysis (“VCA”) algorithm for the signal model (Ψ) are chosen; this choice is made for convenience of implementation and because VCA has shown to provide good sparse representations of hyperspectral-data. Generally, there are two types of signal models; fixed and learned. Fixed models include standard mathematical transformations such as the standard discrete cosine transform (“DCF”), the standard discrete wavelet transform (“DWT”), and the standard discrete Fourier transform (“DFT”). Learned signal models offer potentially sparser representations but must be tuned to a particular dataset; learned signal model creation algorithms include standard non-negative matrix factorisation (“NNMF”), standard K-singular value decomposition (“K-SVD”), standard method of optimal directions (“MOD”), standard generalised principle component analysis (“GPCA”), and standard end-member algorithms. An embodiment of the invention does not require a specific signal model, only one which can sparsely express the sensor data.

Due to the high computational cost of individually recovering every pixel from data set I, an alternative to g_{R}, g*_{R} is employed in an embodiment of the invention. I is divided such that, I⊃Iₖ⊃Iₖ₋₁⊃ . . . ⊃Iᵢ, and for each subset declare an iteration update frequency iₖ≥iₖ₋₁≥ . . . ≥i₁ and update importance factors Hₖ, Hₖ₊₁, . . . , Hᵢ. Now for iteration i let;

g*_{g}ⁱ (θ_{R})=Σ_{f=1}^{k} [symbol] (θ_{R}), [21 ]

where ,

$${R}_{{i}_{l}}^{i} ( {θ}_{R} ) = ( 1 - {{i}_{l}}_{i}^{} ) {l}_{i - 1}^{} + \underline{{{i}_{l}}_{i}^{} {H}_{l}} , ∀ i > 0 , \\ {l}_{0}^{} ( {θ}_{R} ) = 0 , \\ {j}_{i}^{} = \{ \begin{matrix}1 , & i mod j = 0 , \\ 0 , & otherwise .\end{matrix} \qquad [ 22 ]$$

This iterative process is concluded and g*_{R}=g*_{R}ⁱ when the iteration number reaches a maximum or when Equation [23] exceeds a user-determined threshold.

### Joint Objective

If γ ∈ (0,1), then a compromise is made between the two extremal cases; some filters are tuned for target detection while others are tuned for spectral resolution. The joint objective is defined as:

g_{TR} (θ)=γg_{T}(θ_{T})+(1−γ)g_{R}(θ_{R}), [23]

where g_{T} and g_{R} are defined as in Equations [15] and [20], respectively and θ=[θ_{T}, θ_{R}].

The computation technique introduced in Equation [21] is optionally applied to Equation [23] as well. In this compromise case, as a function of γ, let L_{T} of the filters in the filter set be designated for target detection and L_{R} be designated for spectral resolution, such that L=L_{T}+L_{R}. The DE algorithm now proceeds in alternating phases. During the target detection phase, only the L_{T} filters designated for target detection can evolve; but, the other L_{R} filters are-visible to the detector. In the next phase, only the L_{R} spectral resolution filters can evolve; but, similarly, the target detection filters are visible to the CS algorithm. The different phases alternate every iteration: or are separated by several iterations based on the task. This alteration scheme allows for both tasks to be addressed, but at the same time it encourages efficient use of the finite number of trainable liters by developing cross-task features,

Equation [25] can be realized as part of a multi-response-objective Pareto-type optimization procedure where θ is optimized against both response objectives g_{T} and g_{R} simultaneously thus revealing a collection of γ-indicated solutions which are non-dominated. This Pareto-type solution has the benefit of revealing multiple: solutions to the problem during a single optimization procedure. Another benefit is that the parameter space is less constrained (filters are not artificially split between response objectives) and better solutions are possible.

Although a collection of fully trainable filters is ideal for many embodiments of the invention, alternative embodiments of the invention include one or more several handcrafted or commercially available off-the shelf (“COTS”) filters. In such alternative embodiments of the invention, these filters are included in the learning process as fixed filters so the trainable filters do not replicate the performance of the handcrafted or COTS filters.

In some applications, obtaining an actual multispectral image is unnecessary, if only a target or anomaly detection result is required. For these applications (and where y≠1), the CS recovery is optionally ignored, and the detection problem is optionally posed in the compressive domain with standard smashed-filters.

Alternate filter encodings are used in alternative embodiments of the invention. For example, in an alternative embodiment of the invention, flat-top filters of variable width are optionally encoded by introducing a threshold parameter, δᵢ, that sets Beta distribution values above threshold to unity and that sets Beta distribution values below threshold to zero as follows:

$${S}_{i}^{VF} ( {λ}_{i} , {α}_{i} , {β}_{i} ) = \{ \begin{matrix}1 & {f}_{beta} ( {Λ}_{i} \vert {α}_{i} , {β}_{i} ) \geq {δ}_{i} , \\ 0 & {f}_{beta} ( {Λ}_{i} \vert {α}_{i} , {β}_{i} ) < {δ}_{i} ,\end{matrix} \qquad [ 24 ]$$

where λᵢ ∈ Λᵢ is again the center wavelength of the sub-sampling region and where setting all δᵢ=δ is a possible simplification.

Symmetric filters are optionally enforced by setting α=β which yields:

Sᵢ^{S} (λᵢ, αᵢ)= [symbol] (f_{beta}[Λᵢ|αᵢ, αᵢ], λᵢ),

where [symbol] (f, λᵢ) is a circulant-shift operator which centers symmetric function f on λᵢ.

Flat-top filters of a fixed width, w, are optionally specified by:

Sᵢ^{FF} (λᵢ, αᵢ, w)= [symbol] (\tilde{f}_{beta}[Λᵢ |αᵢ, αᵢ, w]), λᵢ), [26]

where \tilde{f}_{beta} is a modified Beta distribution:

$${\tilde{f}}_{beta} ( x \vert α , β , w ) = \{ \begin{matrix}{f}_{beta} ( x + w / 2 \vert α , β ) & x < {λ}_{i} - w / 2 , \\ {f}_{beta} ( x - w / 2 \vert α , β ) & x > {λ}_{i} + w / 2 , \\ 1 & otherwise .\end{matrix} \qquad [ 27 ]$$

Construction constraints are optionally specified by defining a maximum and minimum transmittance operator, [symbol] (S, t, T)=(T−t)S+t such that:

\tilde{S}ᵢ^{T,t}= [symbol] (Sᵢ, t, T). [28]

Alternate embodiments of the invention depend on filter constraints. For example, the filter defined by δ disjoint Beta distributions is written as:

[symbol]

^{DJ} (θ_{DJ})=Σₛ₌₁^{S} Sₛ (λₛ, αₛ, βₛ), [29]

where the disjoint condition is enforced by restricting the set of parameters {αₛ, λₛ, wₛ}ₛ₌₁^{s} such that ∀ij, i≠j:

[symbol]

Sᵢ(αᵢ, λᵢ, wᵢ), Sⱼ (αⱼ, λⱼ, wⱼ) [symbol] =\vec{0}. [30]

Because the number of parameters increases with the number of disjoint Beta distributions, a simplification based on two wavelength ratio rules is able to be introduced:

d₁λ₁=K dₛ λₛ, [31]

w₁ λ₁=κ wₛ λₛ [32]

where dₛ=λₛ₊₁−λₛ and κ, K are constants; so the distance between Beta distributions increases proportional to wavelength (Equation [31]) and the width of the Beta distributions increase in proportion to wavelength (Equation [32]). Given this restricted filter encoding, a lower-dimensional parameter vector, θ_{DJ}=[ [symbol] , α₁, λ₁, w₁, d₁], is all that is -required to define the complete filter

[symbol]

^{DJ*}(θ_{DJ})=Σᵢ₌ₛ^{S} Sₛ (αₛ, λₛ, wₛ)|_{Λ}_{_{B}}, [33]

because αₛ, wₛ, λₛ and dₛ, are defined recursively by Equations [31] and [32]. The sum in Equation [33] is restricted to the support of Λ_{B}.

An embodiment of the invention comprises a computer program, instructions, which computer program instructions embody the steps, functions, filters, and/or subsystems described herein relative to iterative process for generating the highest-rated device response. However, it should be apparent that there could be many different ways of implementing the invention in computer programming, and the invention should not be construed as limited to any one set of computer program instructions. Further, a skilled programmer would be able to write such a computer program to implement an exemplary embodiment based on the appended diagrams and associated, description in the application text. Therefore, disclosure of a particular set of program code instructions is not considered necessary for an adequate understanding of how to make and use the invention. The inventive functionality of the claimed computer program will be explained in more detail in the following description read in conjunction with the program flow in the embodiments of the invention described above.

One of ordinary skill in the art will recognize that the methods, systems, and control laws discussed above may be implemented in software as software modules or instructions, in hardware (e.g., a standard application-specific integrated circuit (“ASIC”)), or in a combination of software and hardware. The methods, systems, and control laws described herein may be implemented on many different types of processing devices by program code comprising program instructions that are executable by one or more processors. The software program instructions may include source code, object code, machine code, or any other stored data that is operable to cause a processing system to perioral methods described herein.

The methods, systems, and control laws may be provided on many different types of standard computer-readable media including standard computer storage mechanisms (e.g., CD-ROM, diskette, RAM, flash memory, computer's hard drive, etc.) that contain instructions for use in execution by a standard processor to perform the methods' operations and implement the systems described herein.

The computer components, software modules, functions and/or data structures described herein may be connected directly or indirectly to each other in order to allow the How of data needed for their operations. It is also noted that software instructions or a module can be implemented for example as a subroutine unit or code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

Systems and methods disclosed herein may use data signals conveyed using networks (e.g., local area network, wide area network, internet, etc.), fiber optic medium, carrier waves, wireless networks, etc. for communication with one or more data-processing devices. The data signals can carry any or all of the data disclosed herein that is provided to or from a device.

Although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to fee inclusive in a manner similar to the term “comprising”.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. A method comprising:
providing a first plurality of numerical support sub-regions,
providing at least one manufacturing constraint;
providing at least one response objective;
generating a first plurality of shapes for the first plurality of numerical support sub-regions, each shape of the first plurality of shapes corresponding to a respective numerical support sub-region of the first plurality of numerical support sub-regions, the each shape of the first plurality of shapes corresponding to a respective function of numerical support within the respective numerical support sub-region of the first plurality of numerical support sub-regions, each respective function of numerical support using:
a first respective center number corresponding to each numerical support sub-region of the first plurality of numerical support sub-regions, said first respective center number depending on the at least one manufacturing constraint,
a first respective Beta distribution,
a first respective alpha Beta distribution shape parameter constrained by the at least one manufacturing constraint, and
a first respective beta Beta distribution shape parameter constrained by the at least one manufacturing constraint;
generating a highest-rated device response using one of directly and indirectly the first plurality of shapes.

2. The method according to claim 1, wherein said generating a highest-rated device response using one of directly and indirectly the first plurality of shapes comprises:
rating a first device response against the at least one response objective, the first device response corresponding to the first plurality of shapes;
providing another plurality of numerical sub-regions;
generating another plurality of shapes for the another plurality of numerical sub-regions, the each shape of the another plurality of shapes corresponding to a respective function of numerical support within the respective numerical support sub-region of the another plurality of numerical support sub-regions, each respective function of numerical support using:
another respective center number corresponding to each numerical support sub-region of the another plurality of numerical support sub-regions, said another respective center number depending on the at least one manufacturing constraint,
another respective Beta distribution,
another respective alpha Beta distribution shape parameter constrained by the at least one manufacturing constraint, and
another respective beta Beta distribution shape parameter constrained by the at least one manufacturing constraint; and
rating another device response against the at least one response objective, the another device response corresponding to the another plurality of shapes;
repeating said providing another plurality of numerical sub-regions, said generating another plurality of shapes for the another plurality of numerical sub-regions, said generating a plurality of shapes for the another plurality of numerical support sub-regions, and rating another device response against the at least one response objective, until the highest-rated device response is generated using a global optimizer.

3. The method according to claim 1, wherein the highest-rated device response comprises one of a filter response, a photonic system response, and an electrical circuit response.

4. The method according to claim 3, further comprising:
building one of a filter corresponding to the filter response, a photonic system corresponding to the photonic system response, and an electrical circuit corresponding to the electrical circuit response.

5. The method according to claim 4, wherein the filter comprises one of a digital filter, an acoustic filter, an electric filter, and an electromagnetic filter.

6. The method according to claim 4, further comprising:
building one of a filter array comprising the filter, a filter wheel comprising the filter, a focal plane array comprising the filter, and a scanning array comprising the filter.

7. The method according to claim 1, wherein the at least one manufacturing constraint comprises at least one of a wavelength-dependent filter roll-off, a wavelength-dependent separation between adjacent sub-regions of the plurality of sub-regions, manufacturing tolerance, minimum transmission manufacturing threshold, maximum transmission manufacturing threshold, and a filter top flatness.

8. The method according to claim 1, wherein the at least one response objective comprises at least one of signal recovery error minimization, target detection error minimization, anomaly detection error minimization, change detection error minimization, classification error minimization, and improved cluster separation.

9. The method according to claim 2, wherein the global optimizer comprises one of a branch-and-bound global optimizer, a Monte-Carlo sampling global optimizer, a stochastic tunneling global optimizer, an evolutionary global optimizer, a swarm-based global optimizer, an ant colony global optimizer, a simulated annealing global optimizer, and a tabu-search-based global optimizer.

10. The method according to claim 2, wherein a region of interest comprises at least one of the first plurality of numerical support sub-regions and the another plurality of numerical support sub-regions, the region of interest comprising one of:
a spectral region of interest comprising a plurality of electromagnetic wavelengths,
an acoustic region of interest comprising a plurality of acoustic wavelengths, and
an electrical region of interest comprising a plurality of electrical frequencies.

11. The method according to claim 2, wherein the first plurality of numerical support sub-regions are at least one of overlapping and disjoint,
wherein the another plurality of numerical support sub-regions are at least one of overlapping and disjoint.
